(19) United States
(12) Patent Application Publication
(10) Pub. No.: US 2026/0339587 A1
(43) Pub. Date: Oct. 29, 2026

(54) VIDEO DISPLAY METHOD, ELECTRONIC DEVICE AND STORAGE MEDIUM

(71) Applicant: Beijing Zitiao Network Technology Co., Ltd., Beijing (CN)

(72) Inventors: Xiaosong WANG, Beijing (CN); Ning WANG, Beijing (CN)

(21) Appl. No.: 19/657,710

(22) Filed: Apr. 24, 2026

(30) Foreign Application Priority Data
Apr. 29, 2025 (CN) 202510555763.0

(51) Int. Cl. G06F 3/14; G06V 10/77

(52) U.S. Cl. CPC G06F 3/14; G06V 10/7715

(57) ABSTRACT

The present disclosure provides a video display method, an electronic device and a storage medium. The method includes: acquiring a key frame of a to-be-displayed video; determining a first image feature of the to-be-displayed video and a second image feature of the key frame; determining a target display parameter of the to-be-displayed video according to the first image feature and the second image feature by using a pre-trained image processing model, where the target display parameter includes at least one of a target window size or a target canvas resolution; and displaying the to-be-displayed video according to the target display parameter.

### CROSS-REFERENCE TO RELATED APPLICATION

This application claims the priority to and benefits of the Chinese Patent Application, No. 202510555763.0, which was filed on Apr. 29, 2025. The aforementioned patent application is hereby incorporated by reference in its entirety.

### TECHNICAL FIELD

The present disclosure relates to the technical field of image processing, and in particular, to a video display method, an electronic device and a medium.

### BACKGROUND

In the prior art, video playback is generally performed directly on a corresponding display device according to original parameters of a video, and an original video that needs to be displayed is directly processed during the playback to improve a corresponding display effect.

However, directly processing the original video leads to a large amount of data to be processed, and the display effect after the processing is not good, affecting the user's experience of watching videos.

### SUMMARY

In view of this, an object of the present disclosure is to provide a video display method, an apparatus, a device, a medium and a program product to solve or partially solve the above technical problems.

Based on the above object, the present disclosure provides a video display method, including: acquiring a key frame of a to-be-displayed video (e.g., a first display video); determining a first image feature of the to-be-displayed video and a second image feature of the key frame; determining a target display parameter (e.g., a first display parameter) of the to-be-displayed video according to the first image feature and the second image feature by using a pre-trained image processing model, where the target display parameter includes at least one of a target window size (e.g., a first window size) or a target canvas resolution (e.g., a first canvas resolution); and displaying the to-be-displayed video according to the target display parameter.

Based on the same concept, the present disclosure further provides a video display apparatus, including: a key frame acquiring module, configured to acquire a key frame of a to-be-displayed video; a parameter determination module, configured to determine a first image feature of the to-be-displayed video and a second image feature of the key frame; an image processing module, configured to determine a target display parameter of the to-be-displayed video according to the first image feature and the second image feature by using a pre-trained image processing model, where the target display parameter includes at least one of a target window size or a target canvas resolution; and a displaying module, configured to display the to-be-displayed video according to the target display parameter.

Based on the same concept, the present disclosure further provides an electronic device, including a memory, a processor, and a computer program stored on the memory and executable on the processor, and the processor, when executing the computer program, is caused to implement the above method.

Based on the same concept, the present disclosure further provides a non-transitory computer-readable storage medium, storing computer instructions, and the computer instructions are configured to cause a computer to execute the above method.

Based on the same concept, the present disclosure further provides a computer program product, including computer program instructions, and the computer program instructions, when running on a computer, cause the computer to execute the above method.

As may be seen from the above, the video display method, the apparatus, the device, the medium and the program product provided by the present disclosure are able to first acquire a key frame of a to-be-displayed video, and the key frame is able to represent a display characteristic of the to-be-displayed video; then determine a first image feature of the to-be-displayed video and a second image feature of the key frame, so that an image processing model may be used to perform picture analysis on the first image feature and the second image feature; in this way, according to the second image feature, the display characteristic of the key frame is analyzed, and in combination with the display characteristic corresponding to the first image feature of the to-be-displayed video, a target display parameter capable of clearly displaying the to-be-displayed video is obtained, so that clear display may be performed on a corresponding display device according to the target display parameter, to improve an effect of a user watching the to-be-displayed video through the display device; at the same time, since data volumes of the first image feature and the second image feature are small, an analysis volume of the image processing model may be reduced, and image processing efficiency is effectively improved.

### BRIEF DESCRIPTION OF DRAWINGS

In order to more clearly explain the technical solutions in the present disclosure or in the related art, the following will briefly introduce the drawings that need to be used in the description of the embodiments or the related art. Obviously, the drawings in the following description are only the embodiments of the present disclosure. For those of ordinary skill in the art, other drawings may be obtained based on these drawings without creative efforts.

FIG. 1 is a schematic diagram of an application scenario of at least one embodiment of the present disclosure;

FIG. 2 is a flowchart of a video display method according to at least one embodiment of the present disclosure;

FIG. 3 is a data flow diagram of at least one embodiment of the present disclosure;

FIG. 4 is a flowchart of a video display method according to another embodiment of the present disclosure;

FIG. 5 is a structural block diagram of a video display apparatus according to at least one embodiment of the present disclosure; and

FIG. 6 is a structural schematic diagram of an electronic device according to at least one embodiment of the present disclosure.

### DETAILED DESCRIPTION

It may be understood that the data involved in the technical solutions (including but not limited to the data itself, acquisition or use of the data) shall comply with requirements of corresponding laws, regulations and related provisions.

The principles and spirit of the present disclosure will be described below with reference to several exemplary implementations. It should be understood that these implementations are only given for those skilled in the art to better understand and implement the present disclosure, and do not limit the scope of the present disclosure in any way. On the contrary, these implementations are provided to make the present disclosure more thorough and complete, and to fully convey the scope of the present disclosure to those skilled in the art.

It may be understood that before using the technical solutions in the embodiments of the present disclosure, the user shall be informed of the type, range of use, use scenarios, etc., of involved personal information in an appropriate manner, and the authorization of the user shall be obtained.

For example, in response to receiving an active request from a user, prompt information is sent to the user to clearly prompt the user that the requested operation will require access to and use of the user's personal information. In this way, the user may independently choose whether to provide the personal information to software or hardware, such as an electronic device, an application, a server or a storage medium, that performs the operations of the technical solutions of the present disclosure based on the prompt information.

As an optional but non-limiting implementation, in response to receiving the active request from the user, the prompt information may be sent to the user in the form of, for example, a pop-up window, and the prompt information may be presented in text in the pop-up window. In addition, the pop-up window may also include a selection control for the user to select "agree" or "disagree" to provide the personal information to the electronic device.

It may be understood that the above process of notifying and acquiring user authorization is only illustrative, and does not limit the implementations of the present disclosure, and other methods that satisfy related laws and regulations may also be applied to the implementations of the present disclosure.

Herein, it should be understood that any number of elements in the drawings is for example rather than limitation, and any naming is only for distinction, without any limiting meaning.

### Glossary of terms

XR: Extended Reality, including at least one of a group consisting of: AR, VR and MR.

AR: Augmented Reality.

VR: Virtual Reality.

MR: Mixed Reality.

Based on the description of the above background art, the following situations also exist in the related art:

Video playback is a very important experience scenario, and the quality such as the clarity of video image quality directly affects the user's experience of watching videos. How to improve the clarity of videos and the user's experience of watching videos as much as possible on the basis of existing hardware is one of the key tasks.

In the related art, there are various image quality enhancement algorithms used in display devices, such as super-resolution, sharpening, and super sampling, which are suitable for different image quality scenarios and may improve the visual quality of images in different situations.

However, in addition to these traditional image quality enhancement methods, the size of a video display window and/or the size of a corresponding canvas resolution used on a display device may also affect the image quality display effect of a video.

Therefore, how to automatically match a corresponding window size and/or canvas resolution for the display device to clearly display the video and improve the user's experience of watching videos has become an urgent technical issue.

Based on the situations described above, the principles and spirit of the present disclosure are explained in detail below with reference to several representative implementations of the present disclosure.

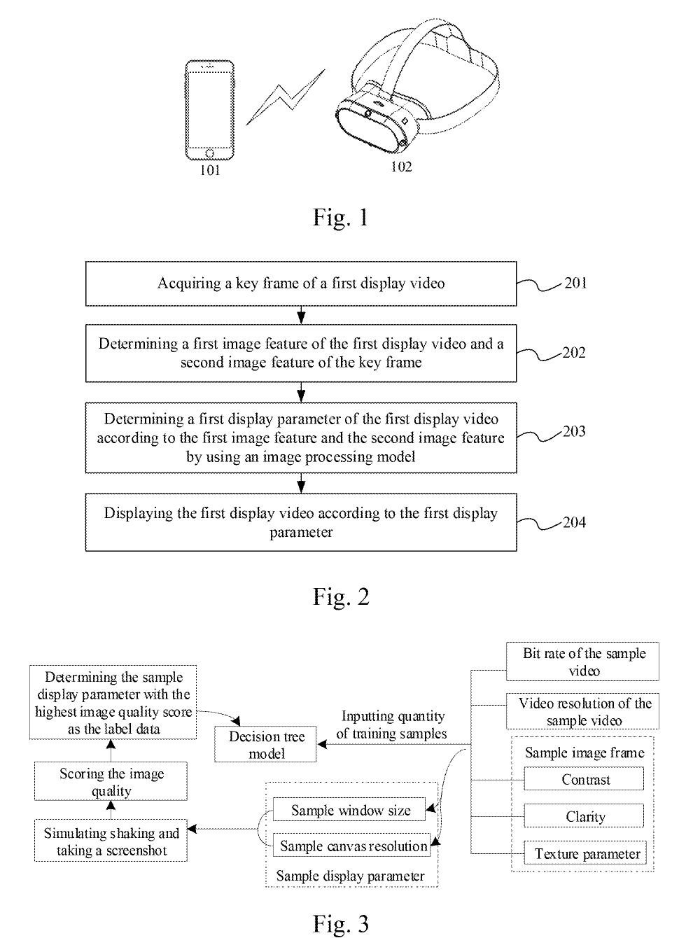

Referring to FIG. 1, it is a schematic diagram of an application scenario of a video display method provided by at least one embodiment of the present disclosure. The application scenario includes a terminal device 101 and a display device 102. The terminal device 101 and the display device 102 may be connected through a wired or wireless communication network. The terminal device 101 includes but is not limited to a desktop computer, a mobile phone, a mobile computer, a tablet computer, a media player, a personal digital assistant (personal digital assistant, PDA), a vehicle-mounted terminal, or other electronic devices that may implement the above functions. The display device 102 includes but is not limited to an extended reality display device (XR display device), a 3D projection device, a 3D display, etc.

The terminal device 101 may acquire a key frame of a to-be-displayed video through a network or a transmission device, retrieve a first image feature of the to-be-displayed video, and determine a corresponding second image feature according to the key frame. A pre-trained image processing model is stored in the terminal device 101, so that the image processing model may be directly used to analyze the first image feature and the second image feature together; according to the second image feature, a display characteristic of the key frame is analyzed, and in combination with a display characteristic corresponding to the first image feature of the to-be-displayed video, a obtained target display parameter (for example, a target window size and/or a target canvas resolution) is more accurate. In this way, the terminal device 101 may receive the to-be-displayed video, enable the display device 102 to clearly display the to-be-displayed video based on the target display parameter, and provide a user with a better experience of watching the to-be-displayed video through the display device.

The video display method according to the exemplary implementations of the present disclosure is described below in combination with the application scenario of FIG. 1. It should be noted that the above application scenario is only shown to facilitate understanding of the spirit and principles of the present disclosure, and the implementations of the present disclosure are not limited in this regard. On the contrary, the implementations of the present disclosure may be applied to any applicable scenario.

At least one embodiment of the present disclosure provides a video display method, and the video display method is applied to a terminal device.

As shown in FIG. 2, the video display method includes:
Step 201: acquiring a key frame of a to-be-displayed video.

During specific implementation, before receiving the to-be-displayed video, a display link of the to-be-displayed video is received in advance, and the key frame of the to-be-displayed video is carried in the display link, so that the key frame may be directly acquired in the display link.

The key frame is one or more frames of images in the to-be-displayed video that are determined to be able to reflect a key feature of the to-be-displayed video after the to-be-displayed video is formed. In addition, if the key frame includes a plurality of frames of images, a thumbnail video is formed and directly carried in the display link.

Step 202: determining a first image feature of the to-be-displayed video and a second image feature of the key frame.

During specific implementation, the first image feature of the to-be-displayed video is carried in the corresponding display link, and the first image feature is able to represent a display characteristic of the to-be-displayed video and a display requirement of the to-be-displayed video.

After the key frame is obtained from the display link, the second image feature of the key frame may be determined according to picture data of the key frame, and the second image feature is able to represent a feature indicator of image content of the key frame. The second image feature is obtained by analyzing and processing the key frame using an image content analysis algorithm.

Step 203: determining a target display parameter of the to-be-displayed video according to the first image feature and the second image feature by using a pre-trained image processing model, where the target display parameter includes: a target window size and/or a target canvas resolution.

During specific implementation, the image processing model is obtained by pre-training an initial model with a large number of training samples. The image processing model includes a decision tree model and/or a deep learning model. The training samples are obtained by capturing corresponding images from a large number of videos and marking corresponding window sizes and/or canvas resolutions.

In a process of analyzing the first image feature and the second image feature, the image processing model analyzes a display characteristic of the key frame according to the second image feature, and performs a comprehensive analysis in combination with the display characteristic corresponding to the first image feature of the to-be-displayed video, so that the obtained target display parameter is more accurate. Thus, the target display parameter is able to meet both a display requirement of the key frame and a display requirement of the to-be-displayed video.

The target display parameter is a feature indicator used for displaying the to-be-displayed video, such as the target window size and/or the target canvas resolution. The target window size refers to a size of a window that displays the to-be-displayed video, and the target canvas resolution refers to a resolution of a transmission texture of the to-be-displayed video.

Step 204: displaying the to-be-displayed video according to the target display parameter.

During specific implementation, the to-be-displayed video is acquired by the terminal device based on the display link, and then a corresponding display screen is controlled to configure a corresponding display window according to the target window size in the target display parameter, and/or, transmit each frame of image of the to-be-displayed video according to the corresponding target canvas resolution, and render the image on the display window for clear display.

For example, the corresponding display screen may be an extended reality display screen of a wearable device. A user pre-sets a distance between the display window and a human eye, adjusts the display window according to the target window size, transmits each frame of image of the to-be-displayed video according to the corresponding target canvas resolution, and renders the image on the display window for three-dimensional display, so that the user may watch the to-be-displayed video through the extended reality display screen of the wearable device.

Through the above solution, the key frame of the to-be-displayed video may be acquired first, and the key frame is able to represent the display characteristic of the to-be-displayed video; then the first image feature of the to-be-displayed video and the second image feature of the key frame are determined, so that the image processing model may be used to perform picture analysis on the first image feature and the second image feature; in this way, according to the second image feature, the display characteristic of the key frame is analyzed, and in combination with the display characteristic corresponding to the first image feature of the to-be-displayed video, the target display parameter capable of clearly displaying the to-be-displayed video is obtained, so that clear display may be performed on the corresponding display device according to the target display parameter, to improve the effect of the user watching the to-be-displayed video through the display device; at the same time, since the data volumes of the first image feature and the second image feature are small, the analysis volume of the image processing model may be reduced, and the picture processing efficiency is effectively improved.

If there is one corresponding key frame, it is possible that the key frame cannot accurately represent the image display characteristic of the to-be-displayed video, and the target display parameter determined by the image processing model will be inaccurate. To avoid this situation, it is necessary to adopt the solution of the following embodiment:

In some embodiments, there are at least two key frames, and the number of key frames may be specifically determined according to the key frames included in a thumbnail video carried in the display link. Specifically, all key frames of the thumbnail video may be selected, or at least two key frames may be selected, and the specific number of selected key frames may be set according to actual operation needs.

Step 103 includes: Step 1031:
for each of the key frames, determining a candidate display parameter corresponding to the key frame according to the first image feature and the second image feature corresponding to the key frame by using the pre-trained image processing model.

During specific implementation, the first image feature of the to-be-displayed video is fixed, but each key frame has a corresponding second image feature, and the second image features of different key frames may be the same or different. Therefore, the image processing model uses the same first image feature and the second image feature corresponding to each key frame as inputs to the image processing model for image analysis and processing, so that each key frame may correspondingly output one candidate display parameter.

The candidate display parameter includes: a candidate window size and/or a candidate canvas resolution; the candidate window size refers to a size of a window that displays the to-be-displayed video, and the candidate canvas resolution refers to a resolution of a transmission texture of the to-be-displayed video.

Step 1032: determining the target display parameter of the to-be-displayed video according to the candidate display parameters respectively corresponding to the at least two key frames.

During specific implementation, the candidate display parameters obtained corresponding to each of the key frames may be the same or different, so it is necessary to select one most appropriate target display parameter from these candidate display parameters to clearly display the to-be-displayed video.

Through the above solution, the plurality of key frames of the to-be-displayed video are determined, and one candidate display parameter is obtained corresponding to each key frame after being processed by the image processing model, so that the most appropriate target display parameter may be selected from the plurality of candidate display parameters, and the situation that the target display parameter determined according to one key frame is inaccurate is avoided.

In some embodiments, step 1032 includes:
step 10321: performing kernel density estimation on the candidate display parameters respectively corresponding to the at least two key frames.
Step 10322: determining the target display parameter of the to-be-displayed video according to a result of the kernel density estimation.

During specific implementation, in order to better screen a plurality of candidate display parameters (where the plurality of candidate display parameters include at least one candidate display parameter, for example, the plurality of candidate display parameters are A1, A1, A1 and A2, where there are two candidate display parameters A1 and A2), it is necessary to calculate a distribution density corresponding to each candidate display parameter. Any candidate display parameter with a distribution density greater than or equal to a set density threshold is selected as the target display parameter, or a candidate display parameter with a highest distribution density is selected as the target display parameter.

The kernel density estimation is able to analyze a distribution feature of each of the plurality of candidate display parameters, and then determine the corresponding distribution density. The kernel density estimation includes at least one of the following: uniform kernel density estimation, triangular kernel density estimation, gamma kernel density estimation, and Gaussian kernel density estimation.

Through the above solution, the distribution density of each candidate display parameter may be estimated by the kernel density, and the accurate target display parameter may be selected according to the distribution density.

As a preferred embodiment, if the obtained plurality of candidate display parameters are all the same, there is no need to perform kernel density estimation, and the same candidate display parameter is directly used as the target display parameter for displaying the to-be-displayed video; if the plurality of candidate display parameters are not all the same, and there are at least two candidate display parameters, it is necessary to use kernel density estimation to determine the distribution density corresponding to each candidate display parameter, and then screen the target display parameter according to the distribution density. In this way, when it is determined that the plurality of candidate display parameters are the same, the processing process of kernel density estimation may be reduced, and while ensuring the accuracy of the determined target display parameter, the computing power may be saved.

As a preferred embodiment, performing kernel density estimation requires a relatively large amount of calculation, so in order to reduce the computing power, a number of each candidate display parameter in the plurality of candidate display parameters may be counted, any candidate display parameter with a number exceeding a number threshold may be selected as the target display parameter, or a candidate display parameter with a largest number may be selected as the target display parameter. Screening directly according to the number may also save computing power, and at the same time, an accurate target display parameter may be selected.

In some embodiments, the first image feature includes at least one of: video resolution and bit rate; and the second image feature includes at least one of: clarity, contrast, and texture parameter.

During specific implementation, the first image feature is carried in the display link of the to-be-displayed video, so that the video resolution and/or the bit rate of the to-be-displayed video may be directly acquired through the display link. The video resolution is used to represent a display size of the to-be-displayed video, and the bit rate is used to represent a transmission character speed of the to-be-displayed video.

The second image feature needs to be obtained by analyzing and calculating the key frame using the image content analysis algorithm, where the clarity may be calculated using an edge detection algorithm, the contrast may be obtained by calculating a standard deviation of grayscale values of the key frame, and the texture parameter may be determined by analyzing a texture feature (such as a color feature or a line feature) in the key frame.

Through the above solution, the image feature of the to-be-displayed video and the image feature of the key frame may be accurately represented according to these specific first image feature and second image feature.

In some embodiments, a training process of the image processing model includes:
step A: acquiring a sample image frame from a sample video.

During specific implementation, the sample video is obtained by screening a large number of videos, and a number of the sample video is greater than or equal to a set number value (for example, 1000 or 10000).

A key frame in a display link of the sample video may be directly used as the sample image frame, or the sample image frame may be captured from the sample video. At least one sample image frame is obtained corresponding to each sample video.

Step B: determining a sample display parameter of the sample image frame, and using the sample display parameter as label data of the sample image frame, where the sample display parameter includes: a sample window size and/or a sample canvas resolution.

During specific implementation, the sample display parameter capable of clearly displaying the sample image frame may be determined manually, and the sample display parameter is used as the label data to label the sample image frame. The sample display parameter of the sample image frame may also be automatically determined through image adjustment analysis, and used as the label data to label the sample image frame. The specific automatic determination process may be to continuously adjust values of the sample window size and/or the sample canvas resolution, and then select the sample window size and/or the sample canvas resolution capable of clearly displaying the sample image frame.

Step C: determining a third image feature of the sample video and a fourth image feature of the sample image frame, and associating the third image feature, the fourth image feature with the label data to obtain a training sample.

During specific implementation, the third image feature may be directly retrieved from the sample video, or the third image feature may be retrieved from the display link of the sample video. The third image feature is able to represent a display characteristic and a display requirement of the sample video. After the sample image frame is determined, analysis and processing are performed using the image content analysis algorithm according to image data of the sample image frame, to obtain the fourth image feature capable of representing a feature indicator of image content of the sample image frame. In this way, the third image feature, the fourth image feature and the determined label data may be associated to form one training sample, one training sample is formed corresponding to each sample image frame, and at least one training sample is obtained corresponding to each sample video.

Step D: performing training processing on a pre-built initial model by using the training sample, and adjusting a parameter of the initial model according to the label data to obtain the image processing model.

During specific implementation, the corresponding initial model may be an initial decision tree model or an initial neural network model, and the initial model may be subjected to supervised training processing by using the training sample with the label data, so that various parameters of the initial model may be adjusted accordingly according to the label data, so that the adjusted initial model may accurately output the same result as the sample display parameter of the label data according to the third image feature and the fourth image feature in the training sample, which proves that the training of the training sample is completed, and then the next training sample is trained.

After it is determined that all training samples are trained, or after it is determined that a loss function reaches a predetermined convergence degree according to a training process, the final initial model is used as the image processing model.

It is determined that the initial model is the initial decision tree model, and the initial decision tree model has a tree structure, including a root node and a plurality of branch nodes. In the training process, the label data in the training sample with the label data is used to adjust parameters corresponding to the root node and the branch nodes of the initial decision tree model, so that the initial decision tree model may output correct label data for the training sample after adjustment, and then the next training sample is trained based on the adjusted initial decision tree model according to the above process.

It is determined that the initial model is the initial neural network model, and the initial neural network model is a neural network structure, including a plurality of layers of neurons (for example, an input layer, a plurality of hidden layers, and an output layer, where a number of hidden layers may be matched and set according to the diversity of training samples and the diversity of label data). In the training process, the input value of the training sample is used as the initial neural network model, and the initial neural network model is used for processing. A loss function is determined according to a difference between the processing result and the corresponding label data, and an adjustment amount of a connection parameter between each layer of neurons of the initial neural network model is determined according to a loss value calculated by the loss function. According to the adjustment amount, each layer of neurons and the connection parameters between the neurons are adjusted to obtain the adjusted initial neural network model, and then based on the adjusted initial neural network model, the next training sample is trained according to the above process.

Through the above solution, the initial model may be trained by using the training sample formed by combining the fourth image feature having the display characteristic of the sample image frame and the third image feature having the display characteristic of the sample video with the accurate label data, so that the initial model may learn the combination feature of the display characteristic of the sample image frame and the display characteristic of the sample video, and then the image processing model capable of accurately analyzing the key frame may be trained.

In some embodiments, step A includes:
Step A1: playing the sample video to determine a capture time point, and capturing a preset number (e.g., a first number) of sample image frames from the sample video according to the capture time point.
During specific implementation, the preset number may be obtained in advance, and the capture time point of the sample video may be determined according to the preset number, so that when the sample video is played, the sample video is paused when the capture time point is reached, and the sample image frame corresponding to the capture time is obtained.
Through the above solution, the preset number of sample image frames may be captured from the sample video according to the response capture time point. For every one frame of sample image frame captured, one training sample may be determined to train the initial model, or after one sample video is completely captured to obtain the preset number of training samples, the preset number of training samples may be used to train the initial model in turn, so that the obtained image processing model after training may be ensured to be more accurate, and the image features of the key frame and the video in the video may be accurately analyzed, and an accurate display parameter may be output.

In some embodiments, the determining the sample display parameter of the sample image frame in step B includes:
Step B1: displaying the sample image frame under at least two preset display parameters (e.g., second display parameters) respectively, and acquiring a display frame corresponding to each of the preset display parameters, where the preset display parameters include: a preset window size (e.g., a second window size) and/or a preset canvas resolution (e.g., a second canvas resolution).
During specific implementation, the preset display parameter is a feature indicator used for displaying the sample image frame, the preset window size refers to a size of a window that displays the sample image frame, and the preset canvas resolution refers to a resolution of a transmission texture of the sample image frame.
The sample image frame may be sequentially displayed on a corresponding display screen according to different preset display parameters, and an image picture of the sample image frame under each preset display parameter is obtained by taking a screenshot, or a recorded video of the sample image frame under each preset display parameter is obtained by recording a screen. The display frame includes the image picture and/or the recorded video.
Step B2: performing image quality scoring on the display frames respectively corresponding to the at least two preset display parameters.
Step B3: determining the sample display parameter corresponding to the sample image frame according to a result of the image quality scoring.

During specific implementation, since there are a relatively large number of display frames corresponding to each sample video, and it is uncertain which display frame has a better display effect, it is necessary to perform scoring processing on image quality of the display frames to obtain image quality scores of each of the display frames. The higher the image quality score, the better the image quality of the corresponding display frame, and the better the experience of watching videos of a user. The image quality scores of each of the display frames of the sample video are sorted, and a preset display parameter corresponding to any display frame with an image quality score greater than or equal to a score threshold may be selected as the sample display parameter of the sample image frame; or, a preset display parameter corresponding to a display frame with a highest image quality score is selected as the sample display parameter of the sample image frame.

Through the above solution, the accurate sample display parameter may be determined as the label data of the sample image frame according to the image quality score of each of the display frames.

The sample display parameter determined according to the above method may have a situation that the sample display parameters corresponding to each of the sample image frames of one sample video are different, which affects the training of the initial model, and the obtained image processing model after training the initial model has low accuracy.

Based on the above problem, as a preferred embodiment, kernel density estimation processing is performed on the sample display parameters determined for each of the sample image frames obtained by the sample video through the above step B3, to determine the distribution density corresponding to each sample display parameter. Any sample display parameter with a distribution density greater than or equal to a set density threshold is selected, or a sample display parameter with a highest distribution density is selected, and the sample display parameter is used as the unified label data for each of the sample image frames of the sample video, so that it may be ensured that the label data used for one sample video is unique, and no confusion will occur.

In some embodiments, a process of determining the preset window size in step B1 includes:
step I: determining an original window size of the sample image frame; and
step II: adjusting the original window size according to at least two first scaling factors to obtain the preset window size corresponding to each of the first scaling factors.

During specific implementation, other display parameters of the sample image frame may be fixed in advance, and the original window size of the sample image frame is adjusted according to the first scaling factor, specifically, the adjustment may be performed according to the first scaling factor from large to small or from small to large.

For each adjustment, the sample image frame is displayed according to the adjusted preset window size, and image quality scoring is performed on the sample image frame through the above step B2. After it is determined that all first scaling factors are adjusted, the image quality score corresponding to each adjusted preset window size may be obtained, and the process of step B3 is performed to determine the accurate preset window size of the sample image frame as the sample display parameter of the sample image frame.

A setting interval and a setting number of the first scaling factor may be set according to actual needs. For example, the setting interval is 0.1 times to 3 times, and the corresponding setting number is 20 or 30.

Through the above solution, the plurality of first scaling factors may be used to adjust the original window size of the sample image frame, so as to ensure that the obtained plurality of preset window sizes may meet the display requirement of the sample image frame, and the most appropriate sample display parameter may be selected from the plurality of preset window sizes.

In some embodiments, a process of determining the preset canvas resolution in step B1 includes:
step I': determining an original canvas resolution of the sample image frame; and
step II': adjusting the original canvas resolution according to at least two second scaling factors to obtain the preset canvas resolution corresponding to each of the second scaling factors.

During specific implementation, other display parameters of the sample image frame may be fixed in advance, and the original image quality resolution of the sample image frame is adjusted according to the second scaling factor, specifically, the adjustment may be performed according to the second scaling factor from large to small or from small to large.

For each adjustment, the sample image frame is displayed according to the adjusted preset image quality resolution, and image quality scoring is performed on the sample image frame through the above step B2. After it is determined that all second scaling factors are adjusted, the image quality score corresponding to each adjusted preset image quality resolution may be obtained, and the process of step B3 is performed to determine the accurate preset image quality resolution of the sample image frame as the sample display parameter of the sample image frame.

A setting interval and a setting number of the second scaling factor may be set according to actual needs. For example, the setting interval is 0.1 times to 3 times, and the corresponding setting number is 20 or 30.

Through the above solution, the plurality of second scaling factors may be used to adjust the original image quality resolution of the sample image frame, so as to ensure that the obtained plurality of preset image quality resolutions may meet the display requirement of the sample image frame, and the most appropriate sample display parameter may be selected from the plurality of preset image quality resolutions.

In addition, as a preferred embodiment, steps I and II may be executed first, and then steps I' and II' are executed to obtain the preset display parameter including the preset window size and the preset canvas resolution. Alternatively, steps I' and II' may be executed first, and then steps I and II are executed to obtain the preset display parameter including the preset window size and the preset canvas resolution.

In some embodiments, step B1 includes:
step B11: displaying the sample image frame on a display screen according to at least two preset display parameters respectively; and step
B12: performing shaking simulation based on a preset shaking amplitude (e.g., a first shaking amplitude) in a display process of the display screen, and acquiring the display frame corresponding to each of the preset display parameters in a process of the shaking simulation.

During specific implementation, in order to adapt to the display situation of the display screen in various unstable scenarios, in the display process according to the corresponding preset display parameter, by simulating the unstable scenario situation according to the preset shaking amplitude, the display frame in the shaking process is acquired, and then when the subsequent process of step B2 is executed according to the display frame, the display effect of the display frame corresponding to the shaking situation may be determined. In this way, the sample display parameter determined through the processes of steps B2 and B3 may adapt to various unstable scenarios of the display screen, and it is determined whether the corresponding display frame has a display situation of flickering and moiré effect, which affects the display image quality.

Through the above solution, the display frame may be acquired in the process of simulating shaking, so that the image quality score obtained according to the display frame is more in line with the real situation, and the image quality score is more accurate, and then the determined sample display parameter is more accurate, thereby ensuring that the image processing model obtained by training with the sample display parameter as the label data has higher accuracy for image recognition and processing.

As a preferred embodiment, it is determined that the display screen is the extended reality display screen of the head-mounted device. The head-mounted device is worn on the head and is easy to shake, and the obtained display frame is more in line with the real scenario of the head-mounted device. Therefore, the image quality score obtained according to the subsequent step B2 is more in line with the real display situation of the head-mounted device and is more accurate.

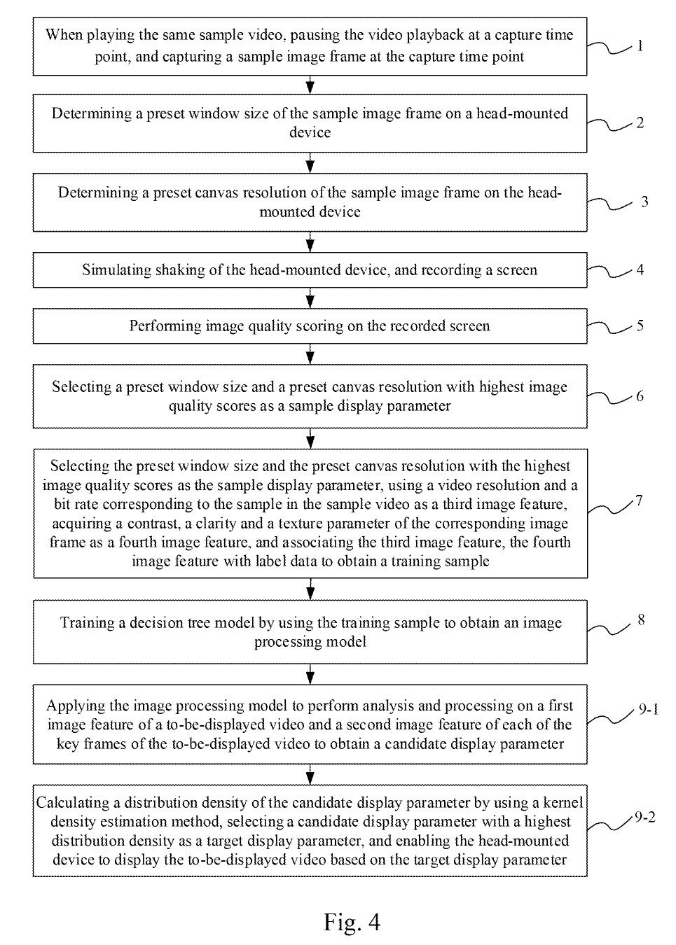

The video display method of the present disclosure is described below with a specific embodiment, which is applied to a terminal device, and a display screen of the terminal device is an extended reality display screen of a head-mounted device, as shown in the data flow diagram of FIG. 3 and the flowchart corresponding to FIG. 4, and a specific execution process is as follows:
1. When playing the same sample video through the head-mounted device, M capture time points are successively captured and the sample video playback is paused, where M≥1, which is a customized value; the sample image frame captured at each capture time point will successively perform subsequent operations in steps 2 to 8.
2. For each sample image frame captured, a window for displaying it on the head-mounted device is set to a different preset window size, and types of different preset window sizes are divided into 30 levels (or X levels, X>1), which are 0.1 times, 0.2 times, 0.3 times,..., 3.0 times of an original window size of the sample image frame (a step size of a first scaling factor is 0.1, starting from 0.1 times and ending at 3.0 times), that is, there are 30 scenarios of different preset window sizes after each capture.
3. In each scenario of the preset window size, a different preset canvas resolution is used for transmission, and types of different preset canvas resolutions are divided into 30 levels (or Y levels, Y>1), which are 0.1 times, 0.2 times,..., 3.0 times of an original canvas resolution of the sample image frame (a step size of a second scaling factor is 0.1, starting from 0.1 times and ending at 3.0 times), that is, after each sample image frame is captured, the above 30 different preset canvas resolutions will be tried to transmit the image data of the sample image frame in each scenario of the preset window size, and the image data is displayed on the head-mounted device. In this way, 30 preset window sizes and 30 preset canvas resolutions are combined to obtain 30×30=900 display scenarios of different preset display parameters.
4. In each display scenario of the preset display parameter, the shaking of the head-mounted device is simulated to determine whether there is a flickering or moiré effect, and a display matrix of the extended display screen on the head-mounted device is controlled to slightly shake according to a preset shaking amplitude to simulate the slight shaking of the head-mounted device. At the same time, a screen is recorded for a preset duration (for example, 1s), and the recorded video is used as the display frame to determine its corresponding image quality display effect (specifically expanded in step 5).
5. The recorded video with the preset duration is decoded, and 10 frames are evenly extracted in sequence. The surrounding black borders of the 10 frames are cropped, and then the 10 frames of images are transmitted together to a video_vida system for image quality scoring. The higher the score, the higher the image quality clarity. The image quality score and the corresponding preset display parameter are recorded.
6. After each sample image frame is repeatedly processed according to the above steps 2 to 5, 900 image quality scoring results corresponding to 900 preset display parameters are obtained, and the 900 image quality scoring results are sorted according to the image quality score from high to low, and the preset display parameter with the highest image quality score is selected as the sample display parameter.
7. Using the sample display parameter as the label data, calculating a contrast, a clarity and a texture parameter of the sample image frame as a fourth image feature, and acquiring a corresponding video resolution and bit rate from the sample video as a third image feature, and associating the third image feature of the sample video, the fourth image feature of the sample image frame with the label data to obtain one training sample.
8. After a large number of training samples are obtained by statistics using massive videos according to the processes of the above steps 1 to 7, the training samples are fed into a decision tree model for training, and parameters of the decision tree model are continuously adjusted according to the corresponding label data, and then the image processing model is obtained by training.

9. In a process of applying the image processing model:
9-1. Since the target window size and the target canvas resolution that need to be used need to be calculated before the to-be-displayed video is played, it is not possible to capture image frames of the to-be-displayed video in turn for processing by the image processing model, because it is very time-consuming. For the to-be-displayed video belonging to the network video, a predetermined number (for example, 8 frames) of key frames are extracted from each to-be-displayed video in advance and synthesized into a new thumbnail video. Before each to-be-displayed video is played, the corresponding display link is acquired first, each of the key frames is determined from the thumbnail video carried in the display link, and the clarity, the contrast and the texture parameter (that is, the second image feature) of the image corresponding to each of the key frames are calculated, and the video resolution and the bit rate (for example, the first image feature) of the to-be-displayed video are acquired as parameters and input to the image processing model to acquire the candidate display parameter (including: the candidate window size and/or the candidate canvas resolution) corresponding to all key frames.
9-2. Using the kernel density estimation method, the distribution density corresponding to the candidate display parameter is calculated, and the candidate display parameter with the highest distribution density is selected as the target display parameter that finally needs to be displayed, so that the head-mounted device displays the to-be-displayed video based on the target display parameter.

It should be noted that the method of the embodiments of the present disclosure may be performed by a single device, such as a computer or a server. The method of embodiments may also be applied to a distributed scenario, which is completed by a plurality of devices cooperating with each other. In the case of such a distributed scenario, one of the plurality of devices may only perform one or more steps of the method of embodiments of the present disclosure, and the plurality of devices will interact with each other to complete the method.

It should be noted that some embodiments of the present disclosure have been described above. Other embodiments are within the scope of the appended claims. In some cases, the actions or steps recited in the claims may be performed in an order different from that in the above embodiments and still achieve desired results. In addition, the process depicted in the drawings does not necessarily require a specific order shown or a sequential order to achieve desired results. In some implementations, multitasking and parallel processing are also possible or may be advantageous.

Based on the same concept, corresponding to the video display method of any of the above embodiments, the present disclosure further provides a video display apparatus.

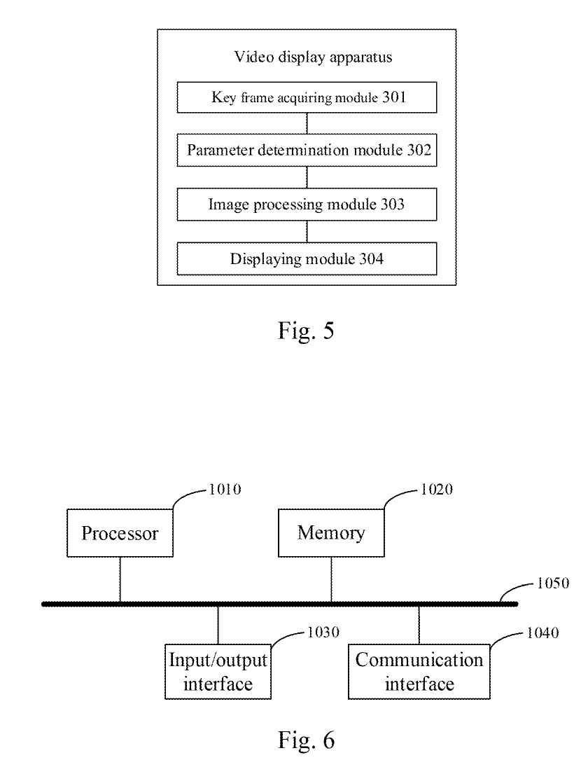

Referring to FIG. 5, the apparatus includes:
a key frame acquiring module 301, configured to acquire a key frame of a to-be-displayed video;
a parameter determination module 302, configured to determine a first image feature of the to-be-displayed video and a second image feature of the key frame;
an image processing module 303, configured to determine a target display parameter of the to-be-displayed video according to the first image feature and the second image feature by using a pre-trained image processing model, where the target display parameter includes: a target window size and/or a target canvas resolution; and
a displaying module 304, configured to display the to-be-displayed video according to the target display parameter.

In some embodiments, there are at least two key frames; and the image processing module 303 is further configured to:
for each of the key frames, determine a candidate display parameter corresponding to the key frame according to the first image feature and the second image feature corresponding to the key frame by using the pre-trained image processing model; and
determine the target display parameter of the to-be-displayed video according to the candidate display parameters respectively corresponding to the at least two key frames.

In some embodiments, the image processing module 303 is further configured to:
perform kernel density estimation on the candidate display parameters respectively corresponding to the at least two key frames; and
determine the target display parameter of the to-be-displayed video according to a result of the kernel density estimation.
In some embodiments, the first image feature includes at least one of video resolution and bit rate; and
the second image feature includes at least one of clarity, contrast and texture parameter.

In some embodiments, the apparatus further includes a training module, including:
a sample acquiring unit, configured to acquire a sample image frame from a sample video;
a label determination unit, configured to determine a sample display parameter of the sample image frame and use the sample display parameter as label data of the sample image frame, where the sample display parameter includes: a sample window size and/or a sample canvas resolution;
an association processing unit, configured to determine a third image feature of the sample video and a fourth image feature of the sample image frame, and associate the third image feature, the fourth image feature with the label data to obtain a training sample; and
a training processing unit, configured to perform training processing on a pre-trained initial model by using the training sample, and adjust a parameter of the initial model according to the label data to obtain the image processing model.

In some embodiments, the sample acquiring unit is further configured to:
play the sample video to determine a capture time point, and capture a preset number of sample image frames from the sample video according to the capture time point.

In some embodiments, the label determination unit is further configured to:
display the sample image frame under at least two preset display parameters respectively, and acquire a display frame corresponding to each of the preset display parameters, where the preset display parameters include: a preset window size and/or a preset canvas resolution;
perform image quality scoring on the display frames respectively corresponding to the at least two preset display parameters; and
determine the sample display parameter corresponding to the sample image frame according to a result of the image quality scoring.

In some embodiments, the label determination unit is further configured to:
determine an original window size of the sample image frame; and
adjust the original window size according to at least two first scaling factors to obtain the preset window size corresponding to each of the first scaling factors.

In some embodiments, the label determination unit is further configured to:
determine an original canvas resolution of the sample image frame; and
adjust the original canvas resolution according to at least two second scaling factors to obtain the preset canvas resolution corresponding to each of the second scaling factors.

In some embodiments, the label determination unit is further configured to:
display the sample image frame on a display screen according to at least two preset display parameters respectively; and
perform shaking simulation based on a preset shaking amplitude in a display process of the display screen, and acquire the display frame corresponding to each of the preset display parameters in a process of the shaking simulation.

For the convenience of description, when describing the above apparatus, the functions are divided into various modules and described separately. Certainly, when implementing the present disclosure, the functions of each of the modules may be implemented in one or more pieces of software and/or hardware.

The apparatus of the above embodiments is configured to implement the corresponding method in any one of the above embodiments, and has the beneficial effects of the corresponding method embodiments, which will not be repeated herein.

Based on the same concept, corresponding to the method of any of the above embodiments, the present disclosure further provides an electronic device, including a memory, a processor, and a computer program stored on the memory and executable on the processor, and the processor, when executing the computer program, implements the method of any one of the above embodiments.

FIG. 6 shows a schematic diagram of a more specific hardware structure of an electronic device provided by the embodiments, and the device may include: a processor 1010, a memory 1020, an input/output interface 1030, a communication interface 1040, and a bus 1050. The processor 1010, the memory 1020, the input/output interface 1030, and the communication interface 1040 are communicatively connected to each other within the device through the bus 1050.

The processor 1010 may be implemented by a general-purpose central processing unit (CPU), a microprocessor, an application specific integrated circuit (ASIC), or one or more integrated circuits, etc., for executing related programs, to implement the technical solutions provided by the embodiments of the specification.

The memory 1020 may be implemented in a form of read-only memory (ROM), a random access memory (RAM), a static storage device, a dynamic storage device, etc. The memory 1020 may store an operating system and other applications, and when implementing the technical solutions provided by the embodiments of the specification through software or firmware, related program codes are stored in the memory 1020 and called by the processor 1010 for execution.

The input/output interface 1030 is used to connect to an input/output module to realize information input and output. The input/output module may be configured as a component in the device (not shown in the figure), or may be external to the device to provide corresponding functions. The input device may include a keyboard, a mouse, a touch screen, a microphone, various sensors, etc., and the output device may include a display, a speaker, a vibrator, an indicator light, etc.

The communication interface 1040 is used to connect to a communication module (not shown in the figure) to implement communication interaction between the device and other devices. The communication module may communicate in a wired manner (for example, a USB, a network cable, etc.), or may communicate in a wireless manner (for example, a mobile network, Wi-Fi, Bluetooth, etc.).

The bus 1050 includes a path for transferring information between the components (for example, the processor 1010, the memory 1020, the input/output interface 1030, and the communication interface 1040) of the device.

It should be noted that although only the processor 1010, the memory 1020, the input/output interface 1030, the communication interface 1040, and the bus 1050 are shown in the above device, during a specific implementation, the device may further include other components necessary for proper operation. In addition, it may be understood by those skilled in the art that the above device may include only the components necessary to implement the solutions of the embodiments of the specification, and not necessarily include all of the components shown in the figure.

The electronic device of the above embodiments is configured to implement the corresponding method in any one of the above embodiments, and has the beneficial effects of the corresponding method embodiments, which will not be repeated herein.

Based on the same concept, corresponding to the method of any of the above embodiments, the present disclosure further provides a non-transitory computer-readable storage medium, storing computer instructions, and the computer instructions are configured to cause a computer to execute the method of any of the above embodiments.

The computer-readable medium in the embodiments includes permanent and non-permanent, removable and non-removable media, and information storage may be implemented by using any method or technology. Information may be computer-readable instructions, data structures, modules of a program, or other data. Examples of the computer storage medium include, but are not limited to, a phase-change memory (PRAM, Parameter Random Access Memory), a static random access memory (SRAM, Static Random-Access Memory), a dynamic random access memory (DRAM, Dynamic Random Access Memory), other types of random access memories (RAMs), a read-only memory (ROM), an electrically erasable programmable read-only memory (EEPROM, Electrically Erasable Programmable read only memory), a flash memory or other memory technologies, a compact disc read-only memory (CD-ROM), a digital video disc (DVD) or other optical storage, a cassette tape, tape or disk storage or other magnetic storage devices, or any other non-transmission media that may be used to store information that may be accessed by a computing device.

The computer instructions stored on the storage medium of the above embodiments are configured to cause the computer to execute the method of any of the above embodiments, and have the beneficial effects of the corresponding method embodiments, which will not be repeated herein.

Based on the same concept, corresponding to the method of any of the above embodiments, the present disclosure further provides a computer program product, including computer program instructions, and the computer program instructions, when running on a computer, cause the computer to execute the method of any of the above embodiments, and have the beneficial effects of the corresponding method embodiments, which will not be repeated herein.

It should be understood by those of ordinary skill in the art that the discussion of any one of the above embodiments is only exemplary, and is not intended to imply that the scope of the present disclosure (including the claims) is limited to these examples; with the concept of the present disclosure, the technical features in the above embodiments or different embodiments may also be combined, the steps may be implemented in any order, and there are many other changes in different aspects of the embodiments of the present disclosure as described above, which are not provided in detail for the sake of simplicity.

In addition, to simplify description and discussion and avoid obscuring an understanding of the embodiments of the present disclosure, well-known power/ground connections to an integrated circuit (IC) chip and other components may or may not be shown in the drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the particular details (e.g., circuitry) are set forth to describe the exemplary embodiments of the present disclosure, it will be apparent to those skilled in the art that the embodiments of the present disclosure may be implemented without these particular details or with variations to these particular details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the foregoing description. For example, the discussed embodiments may be used for other memory architectures such as a DRAM.

The embodiments of the present disclosure are intended to cover all such substitutions, modifications, and variations that fall within the broad scope of the appended claims. Therefore, any omissions, modifications, equivalent substitutions, improvements etc. made within the spirit and principle of the embodiments of the present disclosure are intended to be included within the scope of protection of the present disclosure.

1. A video display method, comprising:
acquiring a key frame of a first display video;
determining a first image feature of the first display video and a second image feature of the key frame;
determining a first display parameter of the first display video according to the first image feature and the second image feature by using an image processing model, wherein the first display parameter comprises at least one of a first window size or a first canvas resolution; and
displaying the first display video according to the first display parameter.

2. The method of claim 1, wherein there are at least two key frames, and the determining the first display parameter of the first display video according to the first image feature and the second image feature by using the image processing model comprises:
determining, for each key frame of the key frames, a candidate display parameter corresponding to the key frame according to the first image feature and the second image feature corresponding to the key frame by using the image processing model; and
determining the first display parameter of the first display video according to candidate display parameters respectively corresponding to the at least two key frames.

3. The method of claim 2, wherein the determining the first display parameter of the first display video according to the candidate display parameters respectively corresponding to the at least two key frames comprises:
performing kernel density estimation on the candidate display parameters respectively corresponding to the at least two key frames; and
determining the first display parameter of the first display video according to a result of the kernel density estimation.

4. The method of claim 1, wherein the first image feature comprises at least one of video resolution or bit rate, and the second image feature comprises at least one of a group consisting of clarity, contrast and texture parameter.

5. The method of claim 1, wherein a training process of the image processing model comprises:
acquiring a sample image frame from a sample video;
determining a sample display parameter of the sample image frame, and using the sample display parameter as label data of the sample image frame, wherein the sample display parameter comprises at least one of a sample window size or a sample canvas resolution;
determining a third image feature of the sample video and a fourth image feature of the sample image frame, and associating the third image feature, the fourth image feature with the label data to obtain a training sample; and
performing training processing on an initial model by using the training sample, and adjusting a parameter of the initial model according to the label data to obtain the image processing model.

6. The method of claim 5, wherein the acquiring the sample image frame from the sample video comprises:
playing the sample video to determine a capture time point; and
capturing a first number of sample image frames from the sample video according to the capture time point.

7. The method of claim 5, wherein the determining the sample display parameter of the sample image frame comprises:
displaying the sample image frame under at least two second display parameters respectively, and acquiring a display frame corresponding to each of the second display parameters, wherein the second display parameters comprise at least one of a second window size or a second canvas resolution;
performing image quality scoring on the display frames respectively corresponding to the at least two second display parameters; and
determining the sample display parameter corresponding to the sample image frame according to a result of the image quality scoring.

8. The method of claim 7, wherein a determination process of the second window size comprises:
determining an original window size of the sample image frame; and
adjusting the original window size according to at least two first scaling factors to obtain the second window size corresponding to each of the first scaling factors.

9. The method of claim 7, wherein a determination process of the second canvas resolution comprises:
determining an original canvas resolution of the sample image frame; and
adjusting the original canvas resolution according to at least two second scaling factors to obtain the second canvas resolution corresponding to each of the second scaling factors.

10. The method of claim 7, wherein the displaying the sample image frame under the at least two second display parameters respectively, and acquiring the display frame corresponding to each of the second display parameters comprises:
displaying the sample image frame on a display screen according to at least two second display parameters respectively; and
performing shaking simulation based on a first shaking amplitude in a display process of the display screen, and acquiring the display frame corresponding to each of the second display parameters in a process of the shaking simulation.

11. An electronic device, comprising a memory, a processor, and a computer program stored on the memory, wherein the computer program is executable on the processor, and the processor, when executing the computer program, is caused to implement a video display method, and the method comprises:
acquiring a key frame of a first display video;
determining a first image feature of the first display video and a second image feature of the key frame;
determining a first display parameter of the first display video according to the first image feature and the second image feature by using an image processing model, wherein the first display parameter comprises at least one of a first window size or a first canvas resolution; and
displaying the first display video according to the first display parameter.

12. The electronic device of claim 11, wherein there are at least two key frames, and the determining the first display parameter of the first display video according to the first image feature and the second image feature by using the image processing model comprises:
determining, for each key frame of the key frames, a candidate display parameter corresponding to the key frame according to the first image feature and the second image feature corresponding to the key frame by using the image processing model; and
determining the first display parameter of the first display video according to candidate display parameters respectively corresponding to the at least two key frames.

13. The electronic device of claim 12, wherein the determining the first display parameter of the first display video according to the candidate display parameters respectively corresponding to the at least two key frames comprises:
performing kernel density estimation on the candidate display parameters respectively corresponding to the at least two key frames; and
determining the first display parameter of the first display video according to a result of the kernel density estimation.

14. The electronic device of claim 11, wherein the first image feature comprises at least one of video resolution or bit rate, and the second image feature comprises at least one of a group consisting of clarity, contrast and texture parameter.

15. The electronic device of claim 11, wherein a training process of the image processing model comprises:
acquiring a sample image frame from a sample video;
determining a sample display parameter of the sample image frame, and using the sample display parameter as label data of the sample image frame, wherein the sample display parameter comprises at least one of a sample window size or a sample canvas resolution;
determining a third image feature of the sample video and a fourth image feature of the sample image frame, and associating the third image feature, the fourth image feature with the label data to obtain a training sample; and
performing training processing on an initial model by using the training sample, and adjusting a parameter of the initial model according to the label data to obtain the image processing model.

16. The electronic device of claim 15, wherein the acquiring the sample image frame from the sample video comprises:
playing the sample video to determine a capture time point; and
capturing a first number of sample image frames from the sample video according to the capture time point.

17. The electronic device of claim 15, wherein the determining the sample display parameter of the sample image frame comprises:
displaying the sample image frame under at least two second display parameters respectively, and acquiring a display frame corresponding to each of the second display parameters, wherein the second display parameters comprise at least one of a second window size or a second canvas resolution;
performing image quality scoring on the display frames respectively corresponding to the at least two second display parameters; and
determining the sample display parameter corresponding to the sample image frame according to a result of the image quality scoring.

18. The electronic device of claim 17, wherein a determination process of the second window size comprises:
determining an original window size of the sample image frame; and
adjusting the original window size according to at least two first scaling factors to obtain the second window size corresponding to each of the first scaling factors.

19. The electronic device of claim 17, wherein a determination process of the second canvas resolution comprises:
determining an original canvas resolution of the sample image frame; and
adjusting the original canvas resolution according to at least two second scaling factors to obtain the second canvas resolution corresponding to each of the second scaling factors.

20. A non-transitory computer-readable storage medium, storing computer instructions, wherein the computer instructions are configured to cause a computer to execute a video display method, and the method comprises:
acquiring a key frame of a first display video;
determining a first image feature of the first display video and a second image feature of the key frame;
determining a first display parameter of the first display video according to the first image feature and the second image feature by using an image processing model, wherein the first display parameter comprises at least one of a first window size or a first canvas resolution; and
displaying the first display video according to the first display parameter.
